(19) United States
(12) Patent Application Publication
(10) Pub. No.: US 2025/0342157 A1
(43) Pub. Date: Nov. 6, 2025

(54) PERFORMANCE AWARE CACHE RESIZING

(71) Applicant: Microsoft Technology Licensing, LLC, Redmond, WA (US)

(72) Inventors: Kapil KHURANA, Hyderabad (IN); Changsong LI, Newcastle, WA (US); Rahul SAWHNEY, Bengaluru (IN); Prateek GOEL, Bengaluru (IN); Pankaj ARORA, Sammamish, WA (US); Ajay KALHAN, Redmond, WA (US); Vivek Ravindranath NARASAYYA, Redmond, WA (US); Manoj SYAMALA, Issaquah, WA (US); Lukas Michael MAAS, Seattle, WA (US); Junfeng DONG, Sammamish, WA (US); Matthaios Alexandros OLMA, Seattle, WA (US); John M. OSLAKE, Seattle, WA (US)

(21) Appl. No.: 18/654,172

(22) Filed: May 3, 2024

(51) Int. Cl. G06F 16/2455; G06F 11/34; G06F 16/2453

(52) U.S. Cl. CPC G06F 16/24552; G06F 11/3419; G06F 16/24542

(57) ABSTRACT

Systems, methods, apparatuses, and computer program products are disclosed for performance aware database cache resizing. A work statistic associated with a database cache is determined based on an execution of a database workload during a first period of time. An acceptable amount of extra work is determined based on the work statistic and a work reclamation ratio (WRR) that is indicative of an acceptable increase in the work statistic during a second period of time subsequent to cache reclamation. A cache reclamation amount is then determined based at least on the acceptable amount of extra work and a current cache size of the database cache. The cache reclamation amount is provided to a cache manager to reduce the size of the database cache.

### BACKGROUND

A database is an organized collection of data managed by a database management system (DBMS) that enables end users to interact with the database. A user interacts with a database by submitting a query to the DBMS that includes one or more database operations configured according to a query language (e.g., structured query language (SQL)). Examples of database operations include adding data to the database, modifying data of the database, and deleting data of the database. Database caches can improve the performance of a database by maintaining frequently and/or recently used information in memory, thus reducing the need to fetch and/or recalculate the information to execute a query. In a Database as a Service (DBaaS) environment, a database cache size needed to maintain a level of performance can vary based on characteristics (e.g., size, type, etc.) of workloads executing against the database. Cache resizing in DBaaS environments enable consistent performance and/or scalability across diverse workloads.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, apparatuses, and computer program products are disclosed for performance aware database cache resizing. A work statistic associated with a database cache is determined based on an execution of a database workload during a first period of time. An acceptable amount of extra work is determined based on the work statistic and a work reclamation ratio (WRR) that is indicative of an acceptable increase in the work statistic during a second period of time subsequent to cache reclamation. A cache reclamation amount is then determined based on at least the acceptable amount of extra work and a current cache size of the database cache. The cache reclamation amount is provided to a cache manager to reduce the size of the database cache.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for resizing a cache based on statistics associated with the cache, in accordance with an embodiment.

FIG. 2 shows a block diagram of an example system for resizing a cache based on a cache reclamation amount that is determined based on an acceptable degradation in performance, in accordance with an embodiment.

FIG. 3 depicts a flowchart of a process for resizing a cache based on a cache reclamation amount that is determined based on an acceptable degradation in performance, in accordance with an embodiment.

FIG. 4 depicts a flowchart of a process for determining a cache reclamation amount based on simulated buffer information, in accordance with an embodiment.

FIG. 5 depicts a flowchart of a process for determining a work reclamation ratio (WRR) based on simulated buffer information, in accordance with an embodiment.

FIG. 6 depicts a flowchart of a process for triggering the generation of new simulated buffer data, in accordance with an embodiment.

FIG. 7 depicts a flowchart of a process for adjusting a cache size based on a size adjustment amount limited by a cache adjustment limit, in accordance with an embodiment.

FIG. 8 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Database cache resizing in DBaaS environments allows customers to balance database performance and memory allocation costs associated with the database cache. For example, when database cache performance is negatively impacted by workload fluctuations, increasing a database cache size can, in embodiments, help maintain a level of database performance. Conversely, when database cache performance is positively impacted by workload fluctuations, decreasing a database cache can, in embodiments, reduce customer costs without significantly impacting database performance.

Embodiments disclosed herein are directed to performance-aware database cache resizing. In embodiments, the performance impact of database cache resizing is considered when resizing a database cache. For instance, when performing database cache reclamation, an acceptable amount of extra work is determined based on the work reclamation ratio (WRR) and a current work statistic, and used to determine a cache reclamation amount that is provided to a cache manager to enable database cache resizing. In embodiments, the WRR is an acceptable tradeoff between an increase in work and a decrease in memory resource costs, and is represented as a ratio of amount of extra work to a total amount of work associated with a database workload. For instance, the WRR is represented by the following equation:

$$WRR = \frac{{W}_{E}}{{W}_{T}} , \qquad ( Eq . 1 )$$

where W_{T} is the total amount of work associated with a database workload during a first period of time and W_{E} is an amount of extra work that is acceptable over a second period of time subsequent to cache reclamation.

In embodiments, the WRR is determined in various ways, such as, but not limited to, based on a constant value, based on input from a customer, based on input from a subject matter expert, based on a current cache size of the database cache, based on a work statistic associated with a database workload, based on an amount of time spent fulfilling data requests in response to a cache miss, based on an cache resizing aggressiveness factor, and/or the like. For instance, in scenarios where a current cache size is relatively large and/or an amount of time spent fulfilling data requests in response to a cache miss is relatively low, a higher WRR is selected to aggressively resize the database cache. In contrast, when a current cache size is relatively small and/or an amount of time spent fulfilling data requests in response to a cache miss is relatively high, in embodiments, a lower WRR is selected to conservatively resize the database cache. In embodiments, one or more WRR guardrails (e.g., 0-20%, 0.0-0.2, etc.) are employed to prevent unreasonable values for WRR. Rewriting the first equation produces the following:

$${W}_{E} = WRR \times {W}_{T} . \qquad ( Eq . 2 )$$

Based on this second equation, an acceptable amount of extra work, W_{E}, is determined, in embodiments, by multiplying WRR by a work statistic (e.g., W_{T}) associated with the database cache, such as, but not limited to, an amount of time spent populating the database cache, an amount of time performing I/O operations to load and/or store a page from storage into a data cache, an amount of time spent compiling, generating, and/or storing a query plan in a plan cache, an amount of time spent obtaining, and/or storing a security token in a security cache, and/or the like.

In embodiments, W_{E} corresponds to an estimated additional processing time (e.g., measured in milliseconds (ms), etc.) that will be incurred by reducing the size of the database cache, such as, but not limited to, additional time spent performing computational (e.g., CPU, GPU, etc.) operations, additional time performing input/output (I/O) operations, and/or additional time waiting on the database cache. For instance, reducing the size of a data cache can result in additional time spent fetching a page from an external and/or remote source (e.g., page server, disk, etc.), reducing the size of a plan cache can result in additional time spent recalculating a database query plan, and/or reducing the size of a security cache can result in additional time spent obtaining security tokens from an external and/or remote source (e.g., token server, etc.) and/or through reauthentication of a user.

In embodiments, a database cache reclamation amount is determined in various ways based on the acceptable amount of extra work, W_{E}, and the current size of the database cache. For instance, a database cache reclamation amount is determined by determining a difference between a current cache size and a new or target cache size that is estimated to result in an amount of extra work that is equal to the acceptable amount of extra work, W_{E}. To determine the new or target cache size, in embodiments, simulated buffer information associated with the database cache is used to determine a cache utility cost that quantifies an expected increase in work resulting from an eviction of a cache entry while executing a customer workload. For instance, a simulated buffer tracks an amount of time between the occurrence of a cache miss and the fulfillment of the request with the requested data. In embodiments, a benefit (e.g., reduction in work) associated with caching a page can be inferred as the inverse of the cache utility cost resulting from evicting (i.e., not caching) a page, and a relationship between a benefit associated with caching a page (e.g., measured in ms/(page*ms) and a cache size (e.g., measured in pages) based on cache utility costs determined for a plurality of cache sizes. For instance, regression analysis is performed on simulated buffer information associated with the database cache collected at various cache sizes to generate a regression function and/or regression model that maps various cache sizes of the database cache to a benefit associated with caching a page at that cache size. In embodiments, the generated function/model includes, but is not limited to, a linear function, a non-linear function, a machine learning model, and/or the like.

In embodiments, the new or target cache size is determined by calculating an area under the regression function between the current cache size and the new or target cache size that is equal to the acceptable amount of extra work, W_{E}. For instance, when the regression function is a linear function, the line can be represented using the following equation:

$${B}_{n} = {B}_{c} \times {R}_{p} - slope \times {R}_{p} \times {R}_{t} , \qquad ( Eq . 3 )$$

where Bₙ represents a new cache benefit at a new cache size, B_{c} represents a current cache benefit at the current cache size, Rₚ represents the period of time between cache resizing events, slope represents the slope of the linear function, and Rₜ represents the target resize amount. In embodiments, Rₜ is represented as a difference between the current cache size and the new or target cache size, as follows:

$${R}_{t} = {S}_{c} - {S}_{n} , \qquad ( Eq . 4 )$$

where S_{c} represents the current cache size of the database cache, and Sₙ represents the new or target cache size of the database cache. Based on the above third and fourth equations, an expected amount of extra work is calculated as the area of a trapezium represented by the following equation:

$$exp . {W}_{E} = - \frac{1}{2} \times slope \times {R}_{p} \times {{R}_{t}}^{2} + {B}_{n} \times {R}_{p} \times {R}_{t} . \qquad ( Eq . 5 )$$

Assuming the expected amount of extra work, exp. W_{E}, is bounded by (e.g., less than and/or equal to, ≤, etc.) the acceptable amount of extra work, W_{E}, the target resize amount, Rₜ, can be solved as one of the two solutions of the following quadratic equation:

$${R}_{t} = \frac{- {B}_{c} \times {R}_{p} \pm \sqrt{{( {B}_{c} \times {R}_{p} )}^{2} - 2 \times slope \times {R}_{p} \times {W}_{E}}}{- slope \times {R}_{p}} . \qquad ( Eq . 6 )$$

In embodiments, the database cache reclamation amount is determined as the difference between the current cache size and the new or target cache size. The determined database cache reclamation amount is provided, in embodiments, to a cache manager to resize the database cache. In embodiments, reclamation guardrails are employed to limit the cache reclamation amount, such as, but not limited to, by limiting the cache reclamation amount to an absolute amount (e.g., number of pages) by which the database cache can be resized, by limiting the cache reclamation amount to a relative amount (e.g., a predetermined percentage of the current cache size) by which the database cache can be resized, by limiting the resultant cache size after resizing to a minimum cache size, and/or the like.

In embodiments, a lack of recent simulated buffer information hinders calculation of a cache reclamation amount. For instance, when a cache size of the database cache is sufficiently large, a database cache can operate for extended periods of time without a cache miss. Since simulated buffer information is generated based on an amount of time required to fulfill a cache request after a cache miss, a lack of cache misses can, in embodiments, result in insufficient simulated buffer information to determine a relationship between a benefit of caching a page and a cache size of the database cache. To trigger generation of simulated buffer information, the cache size of the database cache is periodically reduced, in embodiments, by a small predetermined amount (e.g., one page, etc.) until new simulated buffer information is generated. In embodiments, the generation of simulated buffer information is triggered when a time elapsed since the generation of simulated buffer information satisfies a predetermined recency condition (e.g., exceeds a temporal threshold, etc.)

These and further embodiments are disclosed herein that enable the functionality described above and additional functionality. Such embodiments are described in further detail as follows.

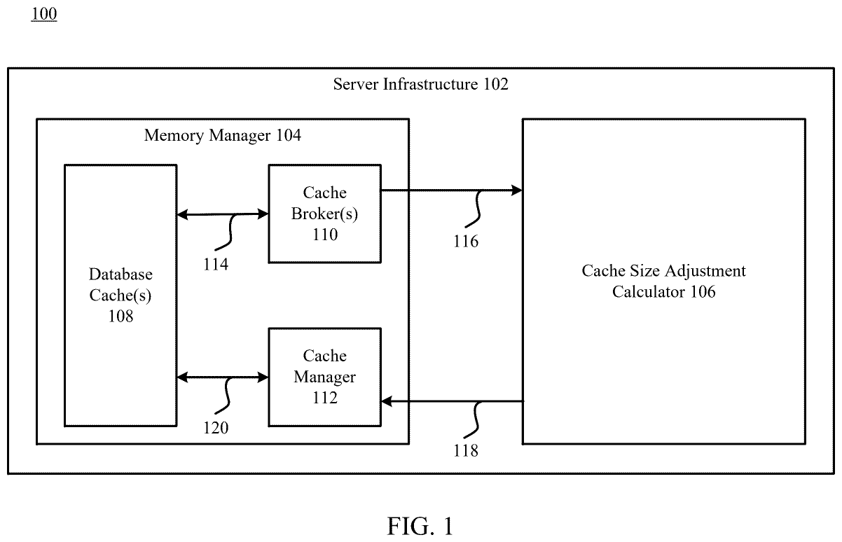

FIG. 1 shows a block diagram of an example system 100 for resizing a cache based on statistics associated with the cache, in accordance with an embodiment. As shown in FIG. 1, system 100 comprises server infrastructure 102 that comprises a memory manager 104 and a cache size adjustment calculator 106. In FIG. 1, memory manager 104 further comprises one or more data caches 108, one or more cache brokers 110, and a cache manager 112. System 100 is described in further detail as follows.

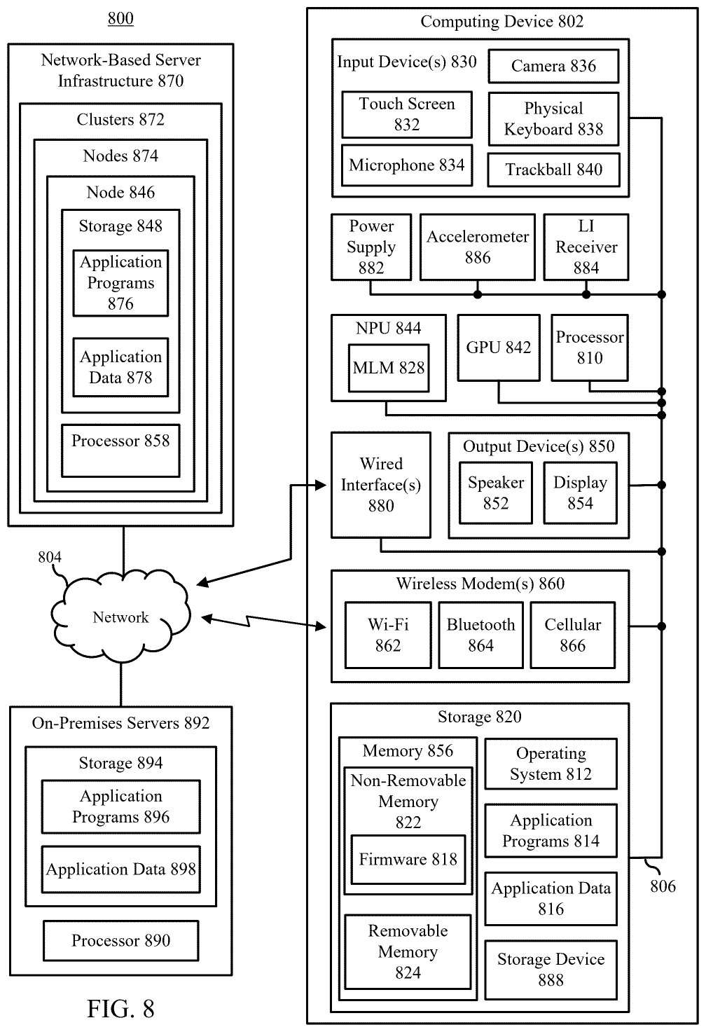

Server infrastructure 102 comprises a network-accessible server set (e.g., cloud-based environment or platform). In an embodiment, the underlying resources of server infrastructure 102 are co-located (e.g., housed in one or more nearby buildings with associated components such as backup power supplies, redundant data communications, environmental controls, etc.) to form a datacenter, are distributed across different regions, and/or are arranged in other manners. As shown in FIG. 1, server infrastructure 102 comprises memory manager 104, cache size adjustment calculator 106, database cache(s) 108, cache broker(s) 110, and cache manager 112. Various example implementations of server infrastructure 102 are described below in reference to FIG. 8 (e.g., network-based server infrastructure 870, and/or components thereof).

Memory manager 104 is configured to manage database cache(s) 108, including, but not limited to, the allocation and/or reclamation of memory associated with database cache(s) 108, the management (e.g., access, caching, eviction, etc.) of data (e.g., pages, query plans, security tokens, etc.) cached in database cache(s) 108, and/or the like. As shown in FIG. 1, memory manager 104 comprises database cache(s) 108, cache broker(s) 110, and cache manager 112.

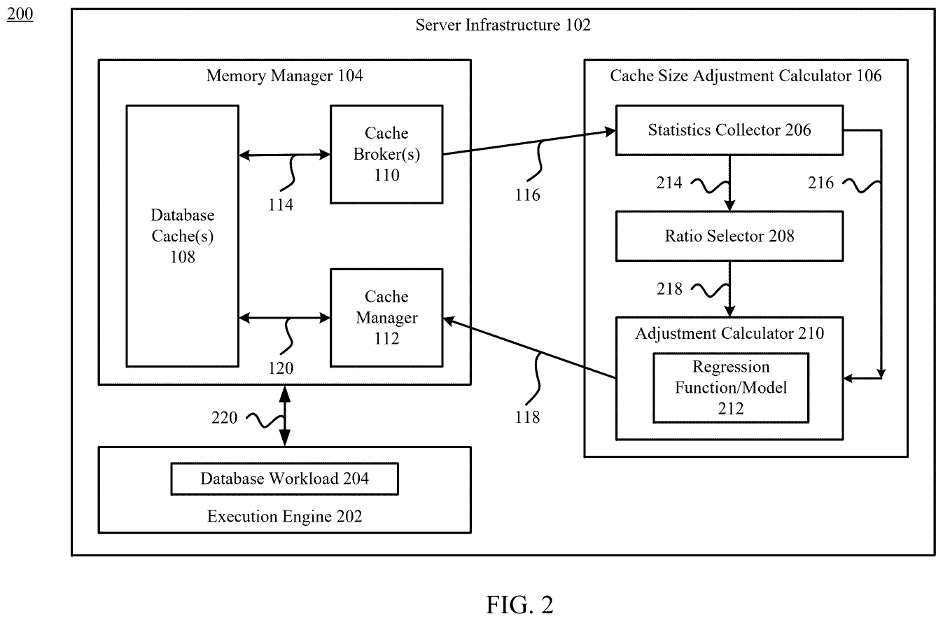

Cache size adjustment calculator 106 is configured to determine a cache size adjustment amount for a database cache based on cache information associated with the database cache. In embodiments, cache size adjustment calculator 106 determines one or more cache resize amounts 118 by which to resize database cache(s) 108 based on statistics 116 associated with database cache(s) 108, and provides, to cache manager 112, the determined cache resize amount(s) 118 to enable resizing of database cache(s) 108. Cache size adjustment calculator 106 will be described in greater detail below in conjunction with FIG. 2.

Database cache(s) 108 comprise one or more database caches configured to store frequently and/or recently used data needed for executing database workloads. In embodiments, database cache(s) 108 comprise one or more of a data cache or buffer pool for caching data (e.g., pages, tables, rows, columns, etc.) of the database, a plan cache for caching query plans (e.g., optimized query plans, etc.) for executing queries against the database, and/or a security cache for caching credentials (e.g., tokens, login credentials, etc.) for executing queries against the database.

Cache broker(s) 110 are configured to manage and coordinate access to data cached in database cache(s) 108. In embodiments, cache broker(s) 110 monitors and/or collects, via communications 114, statistics associated with database cache(s) 108, such as, but not limited to, data (e.g., pages, plans, security tokens, etc.) accessed, access frequency of the data accessed, access recency of data accessed, access patterns of the data accessed, time spent accessing data cached in database cache(s) 108, time spent accessing missing data not cached in database cache(s) 108, and/or the like. In embodiments, cache broker(s) 110 implements one or more caching strategies, such as, but not limited to, least recently used (LRU), least frequently used (LFU), first-in-first-out (FIFO), most recently used (MRU), random replacement, and/or the like. For instance, cache broker(s) 110 determines based on access patterns associated with database cache(s) 108 one or more of: data (e.g., pages, plans, security tokens, etc.) to cache in database cache(s) 108, data to evict from database cache(s) 108, and/or any combination thereof.

Cache manager 112 is configured perform database management tasks associated with database cache(s) 108, such as, but not limited to, allocation of memory resources to database cache(s) 108, reclamation of memory resources from database cache(s) 108, reallocation of memory resources between database cache(s) 108, and/or the like. For instance, cache manager 112 resizes database cache(s) 108 based on cache resize amount(s) 118. In embodiments, cache manager 112 exchanges communications 120 with database cache(s) 108 to perform allocation and/or reclamation of memory resources associated with database cache(s) 108.

Embodiments described herein may operate in various ways to resize a cache based on a cache reclamation amount that is determined based on an acceptable degradation in performance. FIG. 2 shows a block diagram of an example system 200 for resizing a cache based on a cache reclamation amount that is determined based on an acceptable degradation in performance, in accordance with an embodiment. As shown in FIG. 2, system 200 comprises server infrastructure 102, memory manager 104, cache size adjustment calculator 106, database cache(s) 108, cache broker(s) 110, and cache manager 112. Furthermore, server infrastructure 102 further comprises an execution engine 202 that includes a database workload 204 executing thereon. Additionally, cache size adjustment calculator 106 comprises a statistics collector 206, a ratio selector 208, and an adjustment calculator 210. Adjustment calculator 210 further comprises a regression function/model 212. System 200 is described in further detail as follows.

Execution engine 202 is configured to process, optimize, and/or execute queries against a database. In embodiments, execution engine 202 performs various tasks, such as, but not limited to, processing queries and/or commands (e.g., structured query language (SQL), etc.), parsing queries and/or commands into logical operations, and/or generating optimized query plans for efficient execution of the queries and/or commands. In embodiments, execution engine 202 communicates with memory manager 104 via communications 220 to execute the generated query plans.

Database workload 204 comprises a set of tasks performed by execution engine 202 over a period of time. In embodiments, execution of database workload 204 by execution engine 202 produces work statistics associated with the database workload 204, such as, but not limited to, an amount of time spent populating the database cache, an amount of time performing I/O operations to load and/or store a page from storage into a data cache, an amount of time spent compiling, generating, and/or storing a query plan in a plan cache, an amount of time spent obtaining, and/or storing a security token in a security cache, and/or the like. In embodiment, the work statistics associated with database workload 204 are provided, via communications 220, to memory manager 104, cache size adjustment calculator 106, and/or components thereof.

Statistics collector 206 is configured to periodically collect database cache statistics. In embodiments, statistics collector 206 periodically obtains from cache broker(s) 110, statistics 116 associated with database cache(s) 108, such as, but not limited to, work statistics associated with database workload 204, simulated buffer information associated with database cache(s) 108, and/or the like. In embodiments, statistics collector 206 provides statistics 116, or portions thereof, to ratio selector 208 and/or adjustment calculator 210.

Ratio selector 208 is configured to select a WRR based on database cache statistics. In embodiments, ratio selector 208 selects a WRR 218 based on statistics 214 received from statistics collector 206. For instance, ratio selector 208 selects a WRR based on a cache utility cost associated with database workload 204, a current cache size of database cache(s) 108, an amount of work associated with database workload 204 during a predetermined time period, and/or a predetermined WRR limit. For instance, in scenarios where a current cache size is relatively large and/or an amount of time spent fulfilling data requests in response to a cache miss is relatively low, a higher WRR is selected to aggressively resize the database cache. In contrast, when a current cache size is relatively small and/or an amount of time spent fulfilling data requests in response to a cache miss is relatively high, in embodiments, a lower WRR is selected to conservatively resize the database cache. In embodiments, ratio selector 208 determines the amount of work associated with database workload 204 based on work statistics associated with database workload 204 in statistics 214, such as, but not limited to, an amount of time spent populating the database cache, an amount of time performing I/O operations to load and/or store a page from storage into a data cache, an amount of time spent compiling, generating, and/or storing a query plan in a plan cache, an amount of time spent obtaining, and/or storing a security token in a security cache, and/or the like. In embodiments, ratio selector 208 determines the cache utility cost based on simulated buffer information in statistics 214 by determining an increase in an execution time associated with the execution of database workload 204 resulting from a cache miss during the execution of database workload 204. In embodiments, one or more WRR guardrails (e.g., 0-20%, 0.0-0.2, etc.) are employed to prevent unreasonable values for WRR. In embodiments, ratio selector 208 provides the selected WRR 218 to adjustment calculator 210. In embodiments, ratio selector 208 returns a constant value for WRR that can be determined in various ways, such as, but not limited to, based on customer input, based on subject matter expert input, and/or the like.

Adjustment calculator 210 is configured to determine cache resize amounts based on database cache statistics and a selected WRR. For instance, adjustment calculator 210 determines cache resize amount(s) 118 for resizing database cache(s) 108 based on WRR 218 received from ratio selector 208 and statistics 216 received from statistics collector 206. In embodiments, adjustment calculator 210 employs regression function/model 212 to determine cache resize amount(s) 118 based on a current cache size of database cache(s) 108 and an acceptable amount of extra work resulting from reducing a cache size associated with database cache(s) 108. In embodiments, adjustment calculator 210 determines the acceptable amount of extra work based on WRR 218 and a work statistic associated with database workload 204. Adjustment calculator 210 provides, in embodiments, cache resize amount(s) 118 to cache manager 112 to enable cache manager 112 to resize database cache(s) 108.

Regression function/model 212 comprises a function and/or model that maps various cache sizes of the database cache to a benefit associated with caching a page at that cache size. In embodiments, regression function/model 212 is determined by performing regression analysis on simulated buffer information associated with database cache(s) 108 collected at various cache sizes. In embodiments, the generated function/model includes, but is not limited to, a linear function, a non-linear function, a machine learning model, and/or the like. In embodiments, when regression function/model 212 is a linear function as provided by the third equation (i.e., Eq. 3) discussed above, cache resize amount(s) 118 is determined as one of the two solutions of the quadratic equation as provided by the sixth equation (i.e., Eq. 6) discussed above.

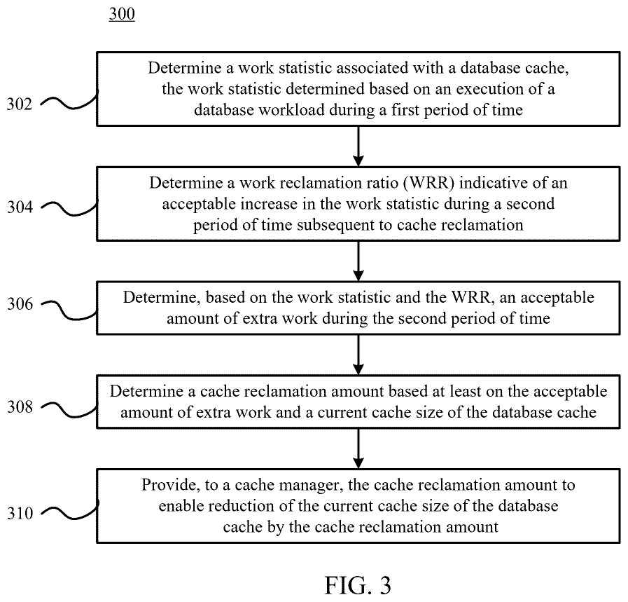

Embodiments described herein may operate in various ways to a cache based on a cache reclamation amount that is determined based on an acceptable degradation in performance. FIG. 3 depicts a flowchart 300 of a process for resizing a cache based on a cache reclamation amount that is determined based on an acceptable degradation in performance, in accordance with an embodiment. Server infrastructure 102, cache size adjustment calculator 106, statistics collector 206, ratio selector 208, adjustment calculator 210, and/or regression function/model 212 may, for example, operate according to flowchart 300. Note that not all steps of flowchart 300 may need to be performed in all embodiments, and in some embodiments, the steps of flowchart 300 may be performed in different orders than shown. Flowchart 300 is described as follows with respect to FIGS. 1-2 for illustrative purposes.

Flowchart 300 starts at step 302, In step 302, a work statistic associated with a database cache is determined based on an execution of a database workload during a first period of time. For example, statistics collector 206 obtains, from cache broker(s) 110, work statistics associated with database cache(s) 108 resulting from execution of database workload 204 by execution engine 202. In embodiments, work statistics associated with the database workload 204, include, but are not limited to, an amount of time spent populating the database cache, an amount of time performing I/O operations to load and/or store a page from storage into a data cache, an amount of time spent compiling, generating, and/or storing a query plan in a plan cache, an amount of time spent obtaining, and/or storing a security token in a security cache, and/or the like. In embodiment, the work statistics associated with database workload 204 are provided, via communications 220, to memory manager 104, cache size adjustment calculator 106, and/or components thereof.

In step 304, a WRR indicative of an acceptable increase in the work statistic during a second period of time subsequent to cache reclamation. For example, ratio selector 208 selects a WRR based on a cache utility cost associated with database workload 204, a current cache size of database cache(s) 108, an amount of work associated with database workload 204 during a predetermined time period, and a predetermined WRR limit.

In step 306, an acceptable amount of extra work is determined based on the work statistic and the WRR. For example, adjustment calculator 210 determines, based on work statistics associated with database workload 204 and WRR 218.

In step 308, a cache reclamation amount is determined based at least on the acceptable amount of extra work and a current cache size of the database cache. For example, adjustment calculator 210 employs regression function/model 212 to determine cache resize amount(s) 118 based on a current cache size of database cache(s) 108 and an acceptable amount of extra work resulting from reducing a cache size associated with database cache(s) 108.

In step 310, the cache reclamation amount is provided to a cache manager to enable reduction of the current cache size of the database cache by the cache reclamation amount. For example, adjustment calculator 210 provides, to cache manager 112, cache resize amount(s) 118 to enable cache manager 112 to resize database cache(s) 108 by the cache resize amount(s) 118.

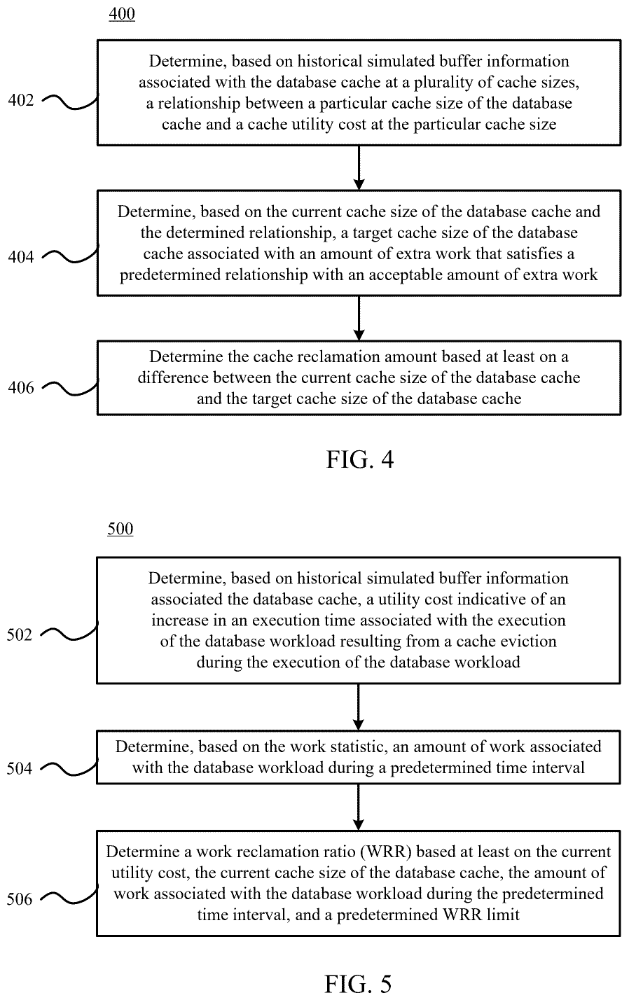

Embodiments described herein may operate in various ways to determine a cache reclamation amount based on simulated buffer information. FIG. 4 depicts a flowchart 400 of a process for determining a cache reclamation amount based on simulated buffer information, in accordance with an embodiment. Server infrastructure 102, cache size adjustment calculator 106, statistics collector 206, ratio selector 208, adjustment calculator 210, and/or regression function/model 212 may, for example, operate according to flowchart 400. Note that not all steps of flowchart 400 may need to be performed in all embodiments, and in some embodiments, the steps of flowchart 400 may be performed in different orders than shown. Flowchart 400 is described as follows with respect to FIGS. 1-2 for illustrative purposes.

Flowchart 400 starts at step 402, In step 402, a relationship between a particular cache size of the database cache and a cache utility cost at the particular cache size is determined based on historical simulated buffer information associated with the database cache at a plurality of cache sizes. For example, adjustment calculator 210 determines regression function/model 212 based on simulated buffer information associated with database cache(s) 108 at a plurality of cache sizes. In embodiments, simulated buffer information associated with database cache(s) 108 is analyzed to determine a cache utility cost that quantifies an expected increase in work resulting from an eviction of a cache entry while executing a customer workload. For instance, cache broker(s) 110 analyzes database cache(s) 108 to determine a cache utility cost associated with a cache size, and provides the determined cache utility cost and the associated cache size to cache size adjustment calculator 106 for determining regression function/model 212. For instance, a simulated buffer tracks an amount of time between the occurrence of a cache miss and the fulfillment of the request with the requested data. In embodiments, a benefit (e.g., reduction in work) associated with caching a page can be inferred as the inverse of the cache utility cost resulting from evicting (i.e., not caching) a page, and a relationship between a benefit associated with caching a page (e.g., measured in ms/(page*ms) and a cache size (e.g., measured in pages) based on cache utility costs determined for a plurality of cache sizes.

In step 404, a target cache size of the database cache associated with an amount of extra work that satisfies a predetermined relationship with an acceptable amount of extra work is determined based on the current cache size of the database cache and the determined relationship. For example, adjustment calculator 210 employs regression function/model 212 to determine a new or target cache size that results an amount of extra work equal to an acceptable amount of extra work resulting from reducing a cache size associated with database cache(s) 108.

In step 406, a cache reclamation amount is determined based at least on a difference between the current cache size of the database cache and the target cache size of the database cache. For example, adjustment calculator 210 determines cache resize amount(s) 118 by determining a difference between a current cache size associated with database cache(s) 108 and the determine new or target cache size.

Embodiments described herein may operate in various ways to a WRR based on simulated buffer information FIG. 5 depicts a flowchart 500 of a process for determining a WRR based on simulated buffer information, in accordance with an embodiment. Server infrastructure 102, cache size adjustment calculator 106, statistics collector 206, ratio selector 208, adjustment calculator 210, and/or regression function/model 212 may, for example, operate according to flowchart 500. Note that not all steps of flowchart 500 may need to be performed in all embodiments, and in some embodiments, the steps of flowchart 500 may be performed in different orders than shown. Flowchart 500 is described as follows with respect to FIGS. 1-2 for illustrative purposes.

Flowchart 500 starts at step 502, In step 502, a utility cost indicative of an increase in an execution time associated with the execution of the database workload resulting from a cache eviction during the execution of the database workload is determined based on historical simulated buffer information associated with the database cache. For example, ratio selector 208 determines the cache utility cost based on simulated buffer information in statistics 214 by determining an increase in an execution time associated with the execution of database workload 204 resulting from a cache miss during the execution of database workload 204.

In step 504, an amount of work associated with the database workload during a predetermined time interval is determined based on the work statistic. For example, ratio selector 208 determines the amount of work associated with database workload 204 based on work statistics associated with database workload 204 in statistics 214, such as, but not limited to, an amount of time spent populating the database cache, an amount of time performing I/O operations to load and/or store a page from storage into a data cache, an amount of time spent compiling, generating, and/or storing a query plan in a plan cache, an amount of time spent obtaining, and/or storing a security token in a security cache, and/or the like.

In step 506, a WRR is determined based at least on the current utility cost, the current cache size of the database cache, the amount of work associated with the database workload during the predetermined time interval, and a predetermined WRR limit. For example, ratio selector 208 selects a WRR based on a cache utility cost associated with database workload 204, a current cache size of database cache(s) 108, an amount of work associated with database workload 204 during a predetermined time period, and/or a predetermined WRR limit. In scenarios where a current cache size is relatively large and/or an amount of time spent fulfilling data requests in response to a cache miss is relatively low, in embodiments, ratio selector 208 selects a higher WRR to aggressively resize the database cache. In contrast, when a current cache size is relatively small and/or an amount of time spent fulfilling data requests in response to a cache miss is relatively high, in embodiments, ratio selector 208 selects a lower WRR to conservatively resize the database cache. In embodiments, one or more WRR guardrails (e.g., 0-20%, 0.0-0.2, etc.) are employed to prevent unreasonable values for WRR. In embodiments, ratio selector 208 provides the selected WRR 218 to adjustment calculator 210. In embodiments, ratio selector 208 returns a constant value for WRR that can be determined in various ways, such as, but not limited to, based on customer input, based on subject matter expert input, and/or the like.

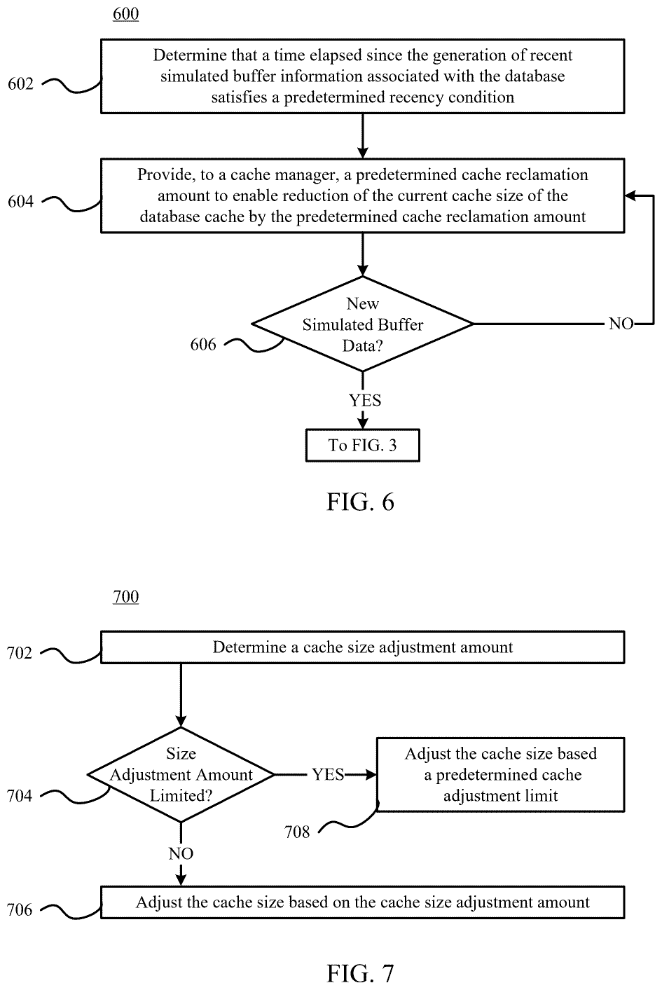

Embodiments described herein may operate in various ways to trigger the generation of new simulated buffer data. FIG. 6 depicts a flowchart of a process for triggering the generation of new simulated buffer data, in accordance with an embodiment. Server infrastructure 102, cache size adjustment calculator 106, statistics collector 206, ratio selector 208, adjustment calculator 210, and/or regression function/model 212 may, for example, operate according to flowchart 600. Note that not all steps of flowchart 600 may need to be performed in all embodiments, and in some embodiments, the steps of flowchart 600 may be performed in different orders than shown. Flowchart 600 is described as follows with respect to FIGS. 1-2 for illustrative purposes.

Flowchart 600 starts at step 602, In step 602, it is determined that a time elapsed since the generation of recent simulated buffer information associated with the database satisfies a predetermined recency condition. For example, cache size adjustment calculator 106 determines that a time since the generation of recent simulated buffer information associated with database cache(s) 108 satisfies a predetermined recency condition (e.g., exceeds a time threshold). In embodiments, cache size adjustment calculator 106 employs a timer to determine whether the predetermined recency conditions is satisfied. For instance, cache size adjustment calculator 106 resets the timer to a predetermined value when simulated buffer information associated with database cache(s) 108 is received from cache broker(s) 110, and determines that the predetermined recency conditions is satisfied when the timer expires (e.g., equals zero).

In step 604, a predetermined cache reclamation amount is provided to a cache manager to enable reduction of the current cache size of the database cache by the predetermined cache reclamation amount. For example, cache size adjustment calculator 106 provides, to cache manager 112, a predetermined reclamation amount (e.g., one page, etc.) to cause cache manager 112 to reduce the cache size of database cache(s) 108 by the predetermined reclamation amount (e.g., one page, etc.).

In step 606, it is determined whether new simulated buffer data is received. For example, statistics collector 206 determines whether statistics 116, received from cache broker(s) 110, includes new simulated buffer information associated with database cache(s) 108. In embodiments, step 606 is performed by statistics collector 206 after a predetermined period of time after step 604 is performed. In embodiments, step 606 is performed when statistics collector 206 receives the next statistics collection update from cache broker(s) 110. If statistics collector 206 determines that statistics 116, received from cache broker(s) 110, does not include new simulated buffer information associated with database cache(s) 108, flowchart 600 proceeds back to step 604, where cache size adjustment calculator 106 provides, to cache manager 112, a predetermined reclamation amount (e.g., one page, etc.) to cause cache manager 112 to further reduce the cache size of database cache(s) 108 by the predetermined reclamation amount (e.g., one page, etc.). If statistics collector 206 determines that statistics 116, received from cache broker(s) 110, does include new simulated buffer information associated with database cache(s) 108, flowchart 600 proceeds to step 302 of FIG. 3.

Embodiments described herein may operate in various ways to adjust a cache size based on a size adjustment amount limited by a cache adjustment limit. FIG. 7 depicts a flowchart 700 of a process for adjusting a cache size based on a size adjustment amount limited by a cache adjustment limit, in accordance with an embodiment. Server infrastructure 102, memory manager 104, cache size adjustment calculator 106, cache manager 112, statistics collector 206, ratio selector 208, adjustment calculator 210, and/or regression function/model 212 may, for example, operate according to flowchart 700. Note that not all steps of flowchart 700 may need to be performed in all embodiments, and in some embodiments, the steps of flowchart 700 may be performed in different orders than shown. Flowchart 700 is described as follows with respect to FIGS. 1-2 for illustrative purposes.

Flowchart 700 starts at step 702, In step 702, a cache size adjustment amount is determined. For example, cache manager 112 receives, from cache size adjustment calculator 106, cache resize amount(s) 118.

In step 704, it is determined whether the size adjustment amount is limited by a predetermined cache adjustment limit. For example, cache manager 112 determines whether cache resize amount(s) 118 is limited by one or more predetermined cache adjustment limits, such as, but not limited to, a cache resize limit (e.g., percent change, absolute change, etc.), a minimum cache size limit, and/or the like. If cache manager 112 determines that cache resize amount(s) 118 does not exceed a predetermined cache adjustment limit, flowchart 700 proceeds to step 706, otherwise flowchart 700 proceeds to step 708.

In step 706, the cache size is adjusted based on the cache size adjustment amount. For example, cache manager 112 adjusts the cache size of database cache(s) 108 by cache resize amount(s) 118.

In step 708, the cache size is adjusted based on the predetermined cache adjustment limit. For example, cache manager 112 adjusts the cache size of database cache(s) 108 based on one or more predetermined cache adjustment limits, including, but not limited to, a predetermined percentage of the current cache size of database cache(s) 108, a predetermined resize amount (e.g., 10 pages, etc.), a minimum cache size, and/or the like.

### III. Example Mobile Device and Computer System Implementation

Server infrastructure 102, memory manager 104, cache size adjustment calculator 106, database cache(s) 108, cache broker(s) 110, cache manager 112, execution engine 202, database workload 204, statistics collector 206, ratio selector 208, adjustment calculator 210, regression function/model 212, and/or the components described therein, and/or the steps of flowcharts 300, 400, 500, 600, and/or 700 are implemented in hardware, or hardware combined with one or both of software and/or firmware. For example, server infrastructure 102, memory manager 104, cache size adjustment calculator 106, database cache(s) 108, cache broker(s) 110, cache manager 112, execution engine 202, database workload 204, statistics collector 206, ratio selector 208, adjustment calculator 210, regression function/model 212, and/or the components described therein, and/or the steps of flowcharts 300, 400, 500, 600, and/or 700 are each implemented as computer program code/instructions configured to be executed in one or more processors and stored in a computer readable storage medium. Alternatively, server infrastructure 102, memory manager 104, cache size adjustment calculator 106, database cache(s) 108, cache broker(s) 110, cache manager 112, execution engine 202, database workload 204, statistics collector 206, ratio selector 208, adjustment calculator 210, regression function/model 212, and/or the components described therein, and/or the steps of flowcharts 300, 400, 500, 600, and/or 700 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 8. FIG. 8 shows a block diagram of an exemplary computing environment 800 that includes a computing device 802. Computing device 802 is an example of server infrastructure 102 and/or components thereof, which each include one or more of the components of computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc. In examples, network 804 includes one or more wired and/or wireless portions. In some examples, network 804 additionally or alternatively includes a cellular network for cellular communications. Computing device 802 is described in detail as follows.

Computing device 802 can be any of a variety of types of computing devices. Examples of computing device 802 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 802 is a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, a graphics processing unit (GPU) 842, a neural processing unit (NPU) 844, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 888. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and in a particular embodiment any combination of the components are present. In examples, components of computing device 802 are mounted to a circuit card (e.g., a motherboard) of computing device 802, integrated in a housing of computing device 802, or otherwise included in computing device 802. The components of computing device 802 are described as follows.

In embodiments, a single processor 810 (e.g., central processing unit (CPU), microcontroller, a microprocessor, signal processor, ASIC (application specific integrated circuit), and/or other physical hardware processor circuit) or multiple processors 810 are present in computing device 802 for performing such tasks as program execution, signal coding, data processing, input/output processing, power control, and/or other functions. In examples, processor 810 is a single-core or multi-core processor, and each processor core is single-threaded or multithreaded (to provide multiple threads of execution concurrently). Processor 810 is configured to execute program code stored in a computer readable medium, such as program code of operating system 812 and application programs 814 stored in storage 820. The program code is structured to cause processor 810 to perform operations, including the processes/methods disclosed herein. Operating system 812 controls the allocation and usage of the components of computing device 802 and provides support for one or more application programs 814 (also referred to as “applications” or “apps”). In examples, application programs 814 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 810 includes one or more general processors (e.g., CPUs) configured with or coupled to one or more hardware accelerators, such as one or more NPUs 844 and/or one or more GPUs 842.

Any component in computing device 802 can communicate with any other component according to function, although not all connections are shown for ease of illustration. For instance, as shown in FIG. 8, bus 806 is a multiple signal line communication medium (e.g., conductive traces in silicon, metal traces along a motherboard, wires, etc.) present to communicatively couple processor 810 to various other components of computing device 802, although in other embodiments, an alternative bus, further buses, and/or one or more individual signal lines is/are present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 888, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 822 includes main memory and is separate from or fabricated in a same integrated circuit as processor 810. As shown in FIG. 8, non-removable memory 822 stores firmware 818 that is present to provide low-level control of hardware. Examples of firmware 818 include BIOS (Basic Input/Output System, such as on personal computers) and boot firmware (e.g., on smart phones). In examples, removable memory 824 is inserted into a receptacle of or is otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 888 are present that are internal and/or external to a housing of computing device 802 and are or are not removable. Examples of storage device 888 include a hard disk drive, a SSD, a thumb drive (e.g., a USB (Universal Serial Bus) flash drive), or other physical storage device.

One or more programs are stored in storage 820. Such programs include operating system 812, one or more application programs 814, and other program modules and program data. Examples of such application programs include computer program logic (e.g., computer program code/instructions) for implementing server infrastructure 102, memory manager 104, cache size adjustment calculator 106, database cache(s) 108, cache broker(s) 110, cache manager 112, execution engine 202, database workload 204, statistics collector 206, ratio selector 208, adjustment calculator 210, regression function/model 212, and/or, and/or each of the components described therein, as well as any of flowcharts 300, 400, 500, 600, 700, and/or any individual steps thereof.

Storage 820 also stores data used and/or generated by operating system 812 and application programs 814 as application data 816. Examples of application data 816 include web pages, text, images, tables, sound files, video data, and other data. In examples, application data 816 is sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 802 through one or more input devices 830 and receives information from computing device 802 through one or more output devices 850. Input device(s) 830 includes one or more of touch screen 832, microphone 834, camera 836, physical keyboard 838 and/or trackball 840 and output device(s) 850 includes one or more of speaker 852 and display 854. Each of input device(s) 830 and output device(s) 850 are integral to computing device 802 (e.g., built into a housing of computing device 802) or are external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 displays information, as well as operating as touch screen 832 by receiving user commands and/or other information (e.g., by touch, finger gestures, virtual keyboard, etc.) as a user interface. Any number of each type of input device(s) 830 and output device(s) 850 are present, including multiple microphones 834, multiple cameras 836, multiple speakers 852, and/or multiple displays 854.

In embodiments where GPU 842 is present, GPU 842 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 842 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 844 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 828. In an example, NPU 844 is configured for a data-driven parallel computing and is highly efficient at processing massive multimedia data such as videos and images and processing data for neural networks. NPU 844 is configured for efficient handling of AI-related tasks, such as speech recognition, background blurring in video calls, photo or video editing processes like object detection, etc.

In embodiments disclosed herein that implement ML models, NPU 844 can be utilized to execute such ML models, of which MLM 828 is an example. For instance, where applicable, MLM 828 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 844 is used to train MLM 828. To train MLM 828, training data is that includes input features (attributes) and their corresponding output labels/target values (e.g., for supervised learning) is collected. A training algorithm is a computational procedure that is used so that MLM 828 learns from the training data. Parameters/weights are internal settings of MLM 828 that are adjusted during training by the training algorithm to reduce a difference between predictions by MLM 828 and actual outcomes (e.g., output labels). In some examples, MLM 828 is set with initial values for the parameters/weights. A loss function measures a dissimilarity between predictions by MLM 828 and the target values, and the parameters/weights of MLM 828 are adjusted to minimize the loss function. The parameters/weights are iteratively adjusted by an optimization technique, such as gradient descent. In this manner, MLM 828 is generated through training by NPU 844 to be used to generate inferences based on received input feature sets for particular applications. MLM 828 is generated as a computer program or other type of algorithm configured to generate an output (e.g., a classification, a prediction/inference) based on received input features, and is stored in the form of a file or other data structure.

In examples, such training of MLM 828 by NPU 844 is supervised or unsupervised. According to supervised learning, input objects (e.g., a vector of predictor variables) and a desired output value (e.g., a human-labeled supervisory signal) train MLM 828. The training data is processed, building a function that maps new data on expected output values. Example algorithms usable by NPU 844 to perform supervised training of MLM 828 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 828 is an LLM, MLM 828 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 828 is trained to learn patterns from unlabeled data. For instance, in embodiments where MLM 828 implements unsupervised learning techniques, MLM 828 identifies one or more classifications or clusters to which an input belongs. During a training phase of MLM 828 according to unsupervised learning, MLM 828 tries to mimic the provided training data and uses the error in its mimicked output to correct itself (i.e., correct weights and biases). In further examples, NPU 844 perform unsupervised training of MLM 828 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 844 need not necessarily be present in all ML model embodiments. In embodiments where ML models are present, any one or more of processor 810, GPU 842, and/or NPU 844 can be present to train and/or execute MLM 828.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). In examples, wireless modem 860 also or alternatively includes other radio-based modem types, such as a Bluetooth modem 864 (also referred to as a “Bluetooth device”) and/or Wi-Fi modem 862 (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and receives power from a battery internal to computing device 802, and/or from a power cord plugged into a power port of computing device 802 (e.g., a USB port, an A/C power port). LI receiver 884 is useable for location determination of computing device 802 and in examples includes a satellite navigation receiver such as a Global Positioning System (GPS) receiver and/or includes other type of location determiner configured to determine location of computing device 802 based on received information (e.g., using cell tower triangulation, etc.). Accelerometer 886, when present, is configured to determine an orientation of computing device 802.

Note that the illustrated components of computing device 802 are not required or all-inclusive, and fewer or greater numbers of components can be present as would be recognized by one skilled in the art. In examples, computing device 802 includes one or more of a gyroscope, barometer, proximity sensor, ambient light sensor, digital compass, etc. In an example, processor 810 and memory 856 are co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein is stored in storage 820 and executed by processor 810.

In some embodiments, server infrastructure 870 is present in computing environment 800 and is communicatively coupled with computing device 802 via network 804. Server infrastructure 870, when present, is a network-accessible server set (e.g., a cloud-based environment or platform). As shown in FIG. 8, server infrastructure 870 includes clusters 872. Each of clusters 872 comprises a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. In examples, any of nodes 874 is a storage node that comprises a plurality of physical storage disks, SSDs, and/or other physical storage devices that are accessible via network 804 and are configured to store data associated with the applications and services managed by nodes 874.

Each of nodes 874, as a compute node, comprises one or more server computers, server systems, and/or computing devices. For instance, a node 874 in accordance with an embodiment includes one or more of the components of computing device 802 disclosed herein. Each of nodes 874 is configured to execute one or more software applications (or “applications”) and/or services and/or manage hardware resources (e.g., processors, memory, etc.), which are utilized by users (e.g., customers) of the network-accessible server set. In examples, as shown in FIG. 8, nodes 874 includes a node 846 that includes storage 848 and/or one or more of a processor 858 (e.g., similar to processor 810, GPU 842, and/or NPU 844 of computing device 802). Storage 848 stores application programs 876 and application data 878. Processor(s) 858 operate application programs 876 which access and/or generate related application data 878. In an implementation, nodes such as node 846 of nodes 874 operate or comprise one or more virtual machines, with each virtual machine emulating a system architecture (e.g., an operating system), in an isolated manner, upon which applications such as application programs 876 are executed.

In embodiments, one or more of clusters 872 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 872 are included in a datacenter in a distributed collection of datacenters. In embodiments, exemplary computing environment 800 comprises part of a cloud-based platform.

In an embodiment, computing device 802 accesses application programs 876 for execution in any manner, such as by a client application and/or a browser at computing device 802.

In an example, for purposes of network (e.g., cloud) backup and data security, computing device 802 additionally and/or alternatively synchronizes copies of application programs 814 and/or application data 816 to be stored at network-based server infrastructure 870 as application programs 876 and/or application data 878. In examples, operating system 812 and/or application programs 814 include a file hosting service client configured to synchronize applications and/or data stored in storage 820 at network-based server infrastructure 870.

In some embodiments, on-premises servers 892 are present in computing environment 800 and are communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 can be shared by on-premises servers 892 between computing devices of the organization, including computing device 802 (when part of an organization) through a local network of the organization, and/or through further networks accessible to the organization (including the Internet). Furthermore, in examples, on-premises servers 892 serve applications such as application programs 896 to the computing devices of the organization, including computing device 802. Accordingly, in examples, on-premises servers 892 include storage 894 (which includes one or more physical storage devices such as storage disks and/or SSDs) for storage of application programs 896 and application data 898 and include a processor 890 (e.g., similar to processor 810, GPU 842, and/or NPU 844 of computing device 802) for execution of application programs 896. In some embodiments, multiple processors 890 are present for execution of application programs 896 and/or for other purposes. In further examples, computing device 802 is configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 is used to implement systems, clients, or devices, or components/subcomponents thereof, disclosed elsewhere herein. In other embodiments, a combination of computing device 802, network-based server infrastructure 870, and/or on-premises servers 892 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 814) are stored in storage 820. Such computer programs can also be received via wired interface(s) 860 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Additional Example Embodiments

In embodiments, a method comprises: determining a work statistic associated with a database cache, the work statistic determined based on an execution of a database workload during a first period of time; determining a WRR indicative of an acceptable increase in the work statistic during a second period of time subsequent to cache reclamation; determining, based on the work statistic and the WRR, an acceptable amount of extra work during the second period of time; determining a cache reclamation amount based at least on the acceptable amount of extra work and a current cache size of the database cache; and providing, to a cache manager, the cache reclamation amount to enable reduction of the current cache size of the database cache by the cache reclamation amount.

In embodiments, determining a work statistic comprises at least one of: determining an amount of time spent populating the database cache from storage; determining an amount of time spent generating a query plan for the database workload and storing the generated query plan in the database cache; or determining an amount of time spent populating the database cache with security tokens.

In embodiments, determining a cache reclamation amount comprises: determining, based on historical simulated buffer information associated the database cache at a plurality of cache sizes, a relationship between a particular cache size of the database cache and a cache utility cost at the particular cache size; determining, based on the current cache size of the database cache and the determined relationship, a target cache size of the database cache associated with an amount of extra work that satisfies a predetermined relationship with the acceptable amount of extra work; and determining the cache reclamation amount based at least on a difference between the current cache size of the database cache and the target cache size of the database cache.

In embodiments, determining, based on historical simulated buffer information associated the database cache at a plurality of cache sizes, a relationship between a particular cache size of the database cache and a cache utility cost at the particular cache size comprises at least one of: determining a regression function based on the historical simulated buffer information; or determining a machine learning model trained based on the historical simulated buffer information to predict the target cache size of the database cache based on the current cache size of the database cache and the acceptable amount of extra work.

In embodiments, determining the cache reclamation amount based at least on a difference between the current cache size of the database cache and the target cache size of the database cache comprises: determining that the difference between the current cache size of the database cache and the target cache size of the database cache satisfies a predetermined relationship with a cache reclamation limit; and determining the cache reclamation amount based on the cache reclamation limit.

In embodiments, determining a WRR comprises: determining, based on historical simulated buffer information associated the database cache, a utility cost indicative of an increase in an execution time associated with the execution of the database workload resulting from a cache eviction during the execution of the database workload; determining, based on the work statistic, an amount of work associated with the database workload during a predetermined time interval; and determining the WRR based at least on the current utility cost, the current cache size of the database cache, the amount of work associated with the database workload during the predetermined time interval, and a predetermined WRR limit.

In embodiments, the method further comprises: determining that a time elapsed since generation of a recent simulated buffer information associated with the database satisfies a predetermined recency condition; and periodically providing, to the cache manager, a predetermined cache reclamation amount to enable reduction of the current cache size of the database cache by the predetermined cache reclamation amount, wherein said periodic providing continues until new simulated buffer information is generated for the database cache.

In embodiments, a system comprises: a processor; and a memory device comprising program code structured to cause the processor to: determine a work statistic associated with a database cache, the work statistic determined based on an execution of a database workload during a first period of time; determine a WRR indicative of an acceptable increase in the work statistic during a second period of time subsequent to cache reclamation; determine, based on the work statistic and the WRR, an acceptable amount of extra work during the second period of time; determine a cache reclamation amount based at least on the acceptable amount of extra work and a current cache size of the database cache; and provide, to a cache manager, the cache reclamation amount to enable reduction of the current cache size of the database cache by the cache reclamation amount.

In embodiments, to determine a work statistic, the program code is structured to cause the processor to at least one of: determine an amount of time spent populating the database cache from storage; determine an amount of time spent generating a query plan for the database workload and storing the generated query plan in the database cache; or determine an amount of time spent populating the database cache with security tokens.

In embodiments, to determine a cache reclamation amount, the program code is structured to cause the processor to: determine, based on historical simulated buffer information associated the database cache at a plurality of cache sizes, a relationship between a particular cache size of the database cache and a cache utility cost at the particular cache size; determine, based on the current cache size of the database cache and the determined relationship, a target cache size of the database cache associated with an amount of extra work that satisfies a predetermined relationship with the acceptable amount of extra work; and determine the cache reclamation amount based at least on a difference between the current cache size of the database cache and the target cache size of the database cache.

In embodiments, to determine, based on historical simulated buffer information associated the database cache at a plurality of cache sizes, a relationship between a particular cache size of the database cache and a cache utility cost at the particular cache size, the program code is structured to cause the processor to at least one of: determine a regression function based on the historical simulated buffer information; or determine a machine learning model trained based on the historical simulated buffer information to predict the target cache size of the database cache based on the current cache size of the database cache and the acceptable amount of extra work.

In embodiments, to determine the cache reclamation amount based at least on a difference between the current cache size of the database cache and the target cache size of the database cache, the program code is structured to cause the processor to: determine that the difference between the current cache size of the database cache and the target cache size of the database cache satisfies a predetermined relationship with a cache reclamation limit; and determine the cache reclamation amount based on the cache reclamation limit.

In embodiments, to determine a WRR, the program code is structured to cause the processor to: determine, based on historical simulated buffer information associated the database cache, a utility cost indicative of an increase in an execution time associated with the execution of the database workload resulting from a cache eviction during the execution of the database workload; determine, based on the work statistic, an amount of work associated with the database workload during a predetermined time interval; and determine the WRR based at least on the current utility cost, the current cache size of the database cache, the amount of work associated with the database workload during the predetermined time interval, and a predetermined WRR limit.

In embodiments, the program code is structured to further cause the processor to: determine that a time elapsed since generation of a recent simulated buffer information associated with the database satisfies a predetermined recency condition; and periodically provide, to the cache manager, a predetermined cache reclamation amount to enable reduction of the current cache size of the database cache by the predetermined cache reclamation amount, wherein said periodic providing continues until new simulated buffer information is generated for the database cache.

In embodiments, a computer-readable storage medium comprises executable instructions that, when executed by a processor, cause the processor to: determine a work statistic associated with a database cache, the work statistic determined based on an execution of a database workload during a first period of time; determine a WRR indicative of an acceptable increase in the work statistic during a second period of time subsequent to cache reclamation; determine, based on the work statistic and the WRR, an acceptable amount of extra work during the second period of time; determine a cache reclamation amount based at least on the acceptable amount of extra work and a current cache size of the database cache; and provide, to a cache manager, the cache reclamation amount to enable reduction of the current cache size of the database cache by the cache reclamation amount.

In embodiments, to determine a work statistic, the executable instructions, when executed by the processor, cause the processor to at least one of: determine an amount of time spent populating the database cache from storage; determine an amount of time spent generating a query plan for the database workload and storing the generated query plan in the database cache; or determine an amount of time spent populating the database cache with security tokens.

In embodiments, to determine a cache reclamation amount, the executable instructions, when executed by the processor, cause the processor to: determine, based on historical simulated buffer information associated the database cache at a plurality of cache sizes, a relationship between a particular cache size of the database cache and a cache utility cost at the particular cache size; determine, based on the current cache size of the database cache and the determined relationship, a target cache size of the database cache associated with an amount of extra work that satisfies a predetermined relationship with the acceptable amount of extra work; and determine the cache reclamation amount based at least on a difference between the current cache size of the database cache and the target cache size of the database cache.

In embodiments, to determine, based on historical simulated buffer information associated the database cache at a plurality of cache sizes, a relationship between a particular cache size of the database cache and a cache utility cost at the particular cache size, the executable instructions, when executed by the processor, cause the processor to at least one of: determine a regression function based on the historical simulated buffer information; or determine a machine learning model trained based on the historical simulated buffer information to predict the target cache size of the database cache based on the current cache size of the database cache and the acceptable amount of extra work.

In embodiments, to determine the cache reclamation amount based at least on a difference between the current cache size of the database cache and the target cache size of the database cache, the executable instructions, when executed by the processor, cause the processor to: determine that the difference between the current cache size of the database cache and the target cache size of the database cache satisfies a predetermined relationship with a cache reclamation limit; and determine the cache reclamation amount based on the cache reclamation limit.

In embodiments, to determine a WRR, the executable instructions, when executed by the processor, cause the processor to: determine, based on historical simulated buffer information associated the database cache, a utility cost indicative of an increase in an execution time associated with the execution of the database workload resulting from a cache eviction during the execution of the database workload; determine, based on the work statistic, an amount of work associated with the database workload during a predetermined time interval; and determine the WRR based at least on the current utility cost, the current cache size of the database cache, the amount of work associated with the database workload during the predetermined time interval, and a predetermined WRR limit.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method comprising:
determining a work statistic associated with a database cache, the work statistic determined based on an execution of a database workload during a first period of time;
determining a work reclamation ratio (WRR) indicative of an acceptable increase in the work statistic during a second period of time subsequent to cache reclamation;
determining, based on the work statistic and the WRR, an acceptable amount of extra work during the second period of time;
determining a cache reclamation amount based at least on the acceptable amount of extra work and a current cache size of the database cache; and
providing, to a cache manager, the cache reclamation amount to enable reduction of the current cache size of the database cache by the cache reclamation amount.

2. The method of claim 1, wherein said determining a work statistic comprises at least one of:
determining an amount of time spent populating the database cache from storage;
determining an amount of time spent generating a query plan for the database workload and storing the generated query plan in the database cache; or
determining an amount of time spent populating the database cache with security tokens.

3. The method of claim 1, wherein said determining a cache reclamation amount comprises:
determining, based on historical simulated buffer information associated the database cache at a plurality of cache sizes, a relationship between a particular cache size of the database cache and a cache utility cost at the particular cache size;
determining, based on the current cache size of the database cache and the determined relationship, a target cache size of the database cache associated with an amount of extra work that satisfies a predetermined relationship with the acceptable amount of extra work; and
determining the cache reclamation amount based at least on a difference between the current cache size of the database cache and the target cache size of the database cache.

4. The method of claim 3, wherein said determining, based on historical simulated buffer information associated the database cache at a plurality of cache sizes, a relationship between a particular cache size of the database cache and a cache utility cost at the particular cache size comprises at least one of:
determining a regression function based on the historical simulated buffer information; or
determining a machine learning model trained based on the historical simulated buffer information to predict the target cache size of the database cache based on the current cache size of the database cache and the acceptable amount of extra work.

5. The method of claim 3, wherein said determining the cache reclamation amount based at least on a difference between the current cache size of the database cache and the target cache size of the database cache comprises:
determining that the difference between the current cache size of the database cache and the target cache size of the database cache satisfies a predetermined relationship with a cache reclamation limit; and
determining the cache reclamation amount based on the cache reclamation limit.

6. The method of claim 1, wherein said determining a WRR comprises:
determining, based on historical simulated buffer information associated the database cache, a utility cost indicative of an increase in an execution time associated with the execution of the database workload resulting from a cache eviction during the execution of the database workload;
determining, based on the work statistic, an amount of work associated with the database workload during a predetermined time interval; and
determining the WRR based at least on the current utility cost, the current cache size of the database cache, the amount of work associated with the database workload during the predetermined time interval, and a predetermined WRR limit.

7. The method of claim 1, further comprising:
determining that a time elapsed since generation of a recent simulated buffer information associated with the database satisfies a predetermined recency condition; and
periodically providing, to the cache manager, a predetermined cache reclamation amount to enable reduction of the current cache size of the database cache by the predetermined cache reclamation amount,
wherein said periodic providing continues until new simulated buffer information is generated for the database cache.

8. A system comprising:
a processor; and
a memory device comprising program code structured to cause the processor to:
determine a work statistic associated with a database cache, the work statistic determined based on an execution of a database workload during a first period of time;
determine a work reclamation ratio (WRR) indicative of an acceptable increase in the work statistic during a second period of time subsequent to cache reclamation;
determine, based on the work statistic and the WRR, an acceptable amount of extra work during the second period of time;
determine a cache reclamation amount based at least on the acceptable amount of extra work and a current cache size of the database cache; and
provide, to a cache manager, the cache reclamation amount to enable reduction of the current cache size of the database cache by the cache reclamation amount.

9. The system of claim 8, wherein, to determine a work statistic, the program code is structured to cause the processor to at least one of:
determine an amount of time spent populating the database cache from storage;
determine an amount of time spent generating a query plan for the database workload and storing the generated query plan in the database cache; or
determine an amount of time spent populating the database cache with security tokens.

10. The system of claim 8, wherein, to determine a cache reclamation amount, the program code is structured to cause the processor to:
determine, based on historical simulated buffer information associated the database cache at a plurality of cache sizes, a relationship between a particular cache size of the database cache and a cache utility cost at the particular cache size;
determine, based on the current cache size of the database cache and the determined relationship, a target cache size of the database cache associated with an amount of extra work that satisfies a predetermined relationship with the acceptable amount of extra work; and
determine the cache reclamation amount based at least on a difference between the current cache size of the database cache and the target cache size of the database cache.

11. The system of claim 10, wherein, to determine, based on historical simulated buffer information associated the database cache at a plurality of cache sizes, a relationship between a particular cache size of the database cache and a cache utility cost at the particular cache size, the program code is structured to cause the processor to at least one of:
determine a regression function based on the historical simulated buffer information; or
determine a machine learning model trained based on the historical simulated buffer information to predict the target cache size of the database cache based on the current cache size of the database cache and the acceptable amount of extra work.

12. The system of claim 10, wherein, to determine the cache reclamation amount based at least on a difference between the current cache size of the database cache and the target cache size of the database cache, the program code is structured to cause the processor to:
determine that the difference between the current cache size of the database cache and the target cache size of the database cache satisfies a predetermined relationship with a cache reclamation limit; and
determine the cache reclamation amount based on the cache reclamation limit.

13. The system of claim 8, wherein, to determine a WRR, the program code is structured to cause the processor to:
determine, based on historical simulated buffer information associated the database cache, a utility cost indicative of an increase in an execution time associated with the execution of the database workload resulting from a cache eviction during the execution of the database workload;
determine, based on the work statistic, an amount of work associated with the database workload during a predetermined time interval; and
determine the WRR based at least on the current utility cost, the current cache size of the database cache, the amount of work associated with the database workload during the predetermined time interval, and a predetermined WRR limit.

14. The system of claim 8, wherein the program code is structured to further cause the processor to:
determine that a time elapsed since generation of a recent simulated buffer information associated with the database satisfies a predetermined recency condition; and
periodically provide, to the cache manager, a predetermined cache reclamation amount to enable reduction of the current cache size of the database cache by the predetermined cache reclamation amount,
wherein said periodic providing continues until new simulated buffer information is generated for the database cache.

15. A computer-readable storage medium comprising executable instructions that, when executed by a processor, cause the processor to:
determine a work statistic associated with a database cache, the work statistic determined based on an execution of a database workload during a first period of time;
determine a work reclamation ratio (WRR) indicative of an acceptable increase in the work statistic during a second period of time subsequent to cache reclamation;
determine, based on the work statistic and the WRR, an acceptable amount of extra work during the second period of time;
determine a cache reclamation amount based at least on the acceptable amount of extra work and a current cache size of the database cache; and
provide, to a cache manager, the cache reclamation amount to enable reduction of the current cache size of the database cache by the cache reclamation amount.

16. The computer-readable storage medium of claim 15, wherein, to determine a work statistic, the executable instructions, when executed by the processor, cause the processor to at least one of:
determine an amount of time spent populating the database cache from storage;
determine an amount of time spent generating a query plan for the database workload and storing the generated query plan in the database cache; or
determine an amount of time spent populating the database cache with security tokens.

17. The computer-readable storage medium of claim 15, wherein, to determine a cache reclamation amount, the executable instructions, when executed by the processor, cause the processor to:
determine, based on historical simulated buffer information associated the database cache at a plurality of cache sizes, a relationship between a particular cache size of the database cache and a cache utility cost at the particular cache size;
determine, based on the current cache size of the database cache and the determined relationship, a target cache size of the database cache associated with an amount of extra work that satisfies a predetermined relationship with the acceptable amount of extra work; and
determine the cache reclamation amount based at least on a difference between the current cache size of the database cache and the target cache size of the database cache.

18. The computer-readable storage medium of claim 17, wherein, to determine, based on historical simulated buffer information associated the database cache at a plurality of cache sizes, a relationship between a particular cache size of the database cache and a cache utility cost at the particular cache size, the executable instructions, when executed by the processor, cause the processor to at least one of:
determine a regression function based on the historical simulated buffer information; or
determine a machine learning model trained based on the historical simulated buffer information to predict the target cache size of the database cache based on the current cache size of the database cache and the acceptable amount of extra work.

19. The computer-readable storage medium of claim 17, wherein, to determine the cache reclamation amount based at least on a difference between the current cache size of the database cache and the target cache size of the database cache, the executable instructions, when executed by the processor, cause the processor to:
determine that the difference between the current cache size of the database cache and the target cache size of the database cache satisfies a predetermined relationship with a cache reclamation limit; and
determine the cache reclamation amount based on the cache reclamation limit.

20. The computer-readable storage medium of claim 15, wherein, to determine a WRR, the executable instructions, when executed by the processor, cause the processor to:
determine, based on historical simulated buffer information associated the database cache, a utility cost indicative of an increase in an execution time associated with the execution of the database workload resulting from a cache eviction during the execution of the database workload;
determine, based on the work statistic, an amount of work associated with the database workload during a predetermined time interval; and
determine the WRR based at least on the current utility cost, the current cache size of the database cache, the amount of work associated with the database workload during the predetermined time interval, and a predetermined WRR limit.
